(19) United States
(12) Patent Application Publication
(10) Pub. No.: US 2025/0107869 A1
(43) Pub. Date: Apr. 3, 2025

(54) DENTAL ATTACHMENT SYSTEMS AND METHODS

(71) Applicant: Align Technology, Inc., San Jose, CA (US)

(72) Inventors: Avi KOPELMAN, Palo Alto, CA (US); Chunhua LI, Cupertino, CA (US)

(21) Appl. No.: 18/976,325

(22) Filed: Dec. 10, 2024

Related U.S. Application Data
(63) Continuation of application No. 15/674,662, filed on Aug. 11, 2017.

(51) Int. Cl. A61C 7/14; A61C 13/15

(52) U.S. Cl. CPC A61C 7/146; A61C 19/003

(57) ABSTRACT

Dental attachment system and methods. A template body may be configured to fit over a patient's dentition and include a dental attachment. The attachment may include an attachment body including an affixing surface configured to interface with a light curable adhesive coating for bonding the dental attachment to a tooth. The attachment body may include an engagement surface configured to engage with a dental appliance. A release layer may cover the engagement surface. The system may include one or more radiation sources configured to emit a first range of wavelengths of radiation for curing the light curable adhesive coating of the dental attachment. The one or more radiation sources may be configured to emit a second range of wavelengths of radiation for degrading the release layer such that the release layer can be removed from the dental attachment to expose the engagement surface.

### CLAIM OF PRIORITY

This patent application is a continuation of U.S. patent application Ser. No. 15/674,662, filed Aug. 11, 2017, titled “DEVICES AND SYSTEMS FOR CREATION OF ATTACHMENTS FOR USE WITH DENTAL APPLIANCES AND CHANGEABLE SHAPED ATTACHMENTS,” now U.S. Patent Application Publication No. 2019/0046297, which is herein incorporated by reference in its entirety.

### BACKGROUND

The present disclosure provides devices and systems for creation of attachments for use with dental appliances and changeable shaped attachments. These concepts can, for example, be beneficial in potentially reducing the cost and increasing the convenience of the orthodontic process.

Dental treatments involve restorative and/or orthodontic procedures to improve the quality of life of a patient. For example, restorative procedures may be designed to implant a dental prosthesis (e.g., a crown, bridge, inlay, onlay, veneer, etc.) intraorally in a patient. Orthodontic procedures may include repositioning misaligned teeth and changing bite configurations for improved cosmetic appearance and/or dental function. Orthodontic repositioning can be accomplished, for example, by applying controlled forces to one or more teeth or a jaw of a patient over a period of time.

As an example, orthodontic repositioning may be provided through a dental process that uses positioning appliances for realigning teeth. Such appliances may utilize a shell of material having resilient properties, referred to as an “aligner,” that generally conforms to a patient's teeth but is slightly out of alignment with a current tooth configuration.

Placement of such an appliance over the teeth may provide controlled forces in specific locations to gradually move the teeth into a new configuration. Repetition of this process with successive appliances in progressive configurations can move the teeth through a series of intermediate arrangements to a final desired arrangement. Such systems typically utilize a set of appliances that can be used serially such that, as the teeth move, a new appliance from the set can be implemented to further move the teeth.

Attachments can be fastened to one or more teeth, for example, via adhesive, and can be used with the shape of the appliance to impart force to move one or more teeth of the patient. The same attachments may be utilized with multiple appliances or attachments may be added, removed, or replaced with other attachment shapes that may impart different force characteristics than a previous appliance and attachment combination (i.e., appliance and one or more attachments).

Dental treatments with a set of appliances may involve repeated patient visits to an orthodontist or other treatment professional in order to verify that the dental treatment is proceeding as anticipated. For instance, an orthodontist may determine during a patient visit that the orthodontic procedure, such as repositioning misaligned teeth, is not proceeding as planned and may alter the procedure or that the treatment is progressing according to the treatment plan, but that a change in the attachment positioning or type of attachment used may need to be changed to move to the next stage in treatment.

“At home orthodontics” is a concept wherein, patients will take their own impression or photos (or go to an imaging center that will take the impression or scan a patient's dentition) and send that impression or other information to a dental appliance fabricator. At the dental appliance fabricator, dental professionals assess the impression or other information to develop a treatment plan and send the dental appliances (e.g., aligners) to the patient to treat their malocclusion at home. Another option is that the complete treatment plan will be created by computer executable instructions using the impression or collected information, orthodontic rules, and machine learning algorithms to precision and recommend a treatment plan for a patient.

Some orthodontic teeth movements cannot be accomplished without the use of attachments. This disclosure will provide different ways of preparing an area on a tooth for placement of an attachment, precisely positioning, affixing, and removing dental attachments as well as concepts for changing the shape of the attachments for use at different time during treatment or to aid in removal of the attachments.

### BRIEF DESCRIPTION OF THE DRAWINGS

FIG. 1 illustrates an attachment template tray for the placement of an attachment on one of a patient's teeth according to a number of embodiments of the present disclosure.

FIG. 2 illustrates an attachment template tray having a plurality of light sources thereon according to a number of embodiments of the present disclosure.

FIG. 3 illustrates an attachment template tray system having a tray with contacts and a lighting component that attaches to the tray according to a number of embodiments of the present disclosure.

FIG. 4 illustrates an attachment template tray system having an attachment template tray and a lighting component that is placed around the attachment template tray according to a number of embodiments of the present disclosure.

FIG. 5 illustrates another attachment template tray system having an attachment template tray and a lighting component that is placed around the attachment template tray according to a number of embodiments of the present disclosure.

FIGS. 6A-6C illustrate an attachment that changes shape over a period of time according to a number of embodiments of the present disclosure.

FIGS. 7A-7C illustrate a series of dental appliances designed to work in conjunction with an attachment that changes shape over a period of time according to a number of embodiments of the present disclosure.

FIG. 8 illustrates another concept wherein a shear force can be provided by a removal appliance to remove the attachment from a tooth of a patient according to a number of embodiments of the present disclosure.

FIG. 9 illustrates an embodiment with a nonactive engagement surface hidden under the outer surface of the attachment according to a number of embodiments of the present disclosure.

FIGS. 10A-10E illustrate an embodiment of a dental attachment affixing system according to a number of embodiments of the present disclosure.

FIG. 11 illustrates a computing system for use in a number of embodiments of the present disclosure.

### DETAILED DESCRIPTION

The present disclosure provides devices, systems, and methods for creation of attachments for use with dental appliances and changeable shaped attachments. For example, the placement of attachments typically requires that the treatment professional create the attachment from a mixture of material, shape the attachment in a mold, cure the attachment using hand held light source, apply an adhesive to a surface of the attachment, position, orient, and hold the cured attachment on the tooth of a patient with one hand, and use the light source to cure the adhesive with the other hand. Given the sometimes tight workspace provided by a patient's mouth, it can be difficult to properly place an attachment at the correct position and in the correct orientation with respect to the tooth surface.

For instance, having to hold the attachment in place, plus a hand held light source with the hands of the treatment professional in proximity to the mouth of the patient, it can be difficult to see into the mouth of the patient and can be difficult to maneuver the attachment to the correct position and orientation.

Additionally, due to the precise interaction between the attachment and the dental appliance that is specifically designed to work with the particular attachment that is to be attached to a patient's tooth at a precise position and orientation, errors in placement of the attachment on the tooth surface, either in position or orientation, can lead to improper force provided when the dental appliance interacts with the attachment, or the dental appliance may not fit over the attachment at all. Further, when multiple attachments are used, the placement of the attachments becomes even more critical, since small placement errors made with respect to each attachment can affect the fit of the dental appliance with respect to the other attachments.

Embodiments of the present disclosure provide methods, devices, and systems that can aid in positioning attachments. For example, in one embodiment, an attachment template tray for creating and placing attachments used in moving teeth of a patient can include an attachment template tray body having a first surface shaped to conform to the contours of exterior surfaces of one or more teeth of a patient and including a portion of the first surface that provides a cavity to form the exterior surfaces of an attachment that is to be attached to the exterior surface of one of the teeth and an integrated light source, power source, and actuation mechanism on the body of the attachment template tray, wherein the power source provides power to the light source when the actuation mechanism is actuated.

The portion of the first surface shaped to accommodate an attachment that is to be attached to the exterior surface of the tooth can, for example, be a well for the placement of a light curable material therein that is used to form the attachment. In some embodiments, the attachment can already be cured and the attachment template tray, instead, includes a cured attachment positioned in the cavity. In such embodiments, a provided one or more light sources are used to cure the attachment, if it has not been cured, as will be described in more detail below.

In order for the attachment to be affixed to the tooth, in some implementations, a bonding material is used. For example, the attachment template tray can include a light curable adhesive material on a surface of the attachment for affixing the attachment to the tooth. This bonding material can be cured using a provided one or more light sources. However, in some embodiments, the bonding material is the attachment material that is used to form the attachment.

In some embodiments, the curing of the attachment shape and the affixing of the attachment to the surface of the tooth can be accomplished at the same time. Alternatively, the attachment shape may be cured and then additional attachment material may be added and cured to affix the attachment to the surface of the tooth.

In some such embodiments, the curing of the attachment and the affixing of the attachment to the tooth can be accomplished in one step (e.g., light applied to the attachment both cures the attachment material and secures it to the tooth surface).

As stated above, the attachment template tray can have a cavity that has interior surfaces that are used to shape the exterior surfaces of the attachment. However, since the attachment template tray is to be placed in the mouth of the patient and positioned to hold the attachment in the proper position and orientation, in some implementations, it is desirable to fabricate at least a portion of the body from of a light transmissive material to allow light from the light source to cure a light curable material that is in contact with the tooth.

Accordingly, in some embodiments, at least a portion of the body is made of a transparent material that is transparent to light. However, in some embodiments, the light used to cure and/or adhere the attachment to the tooth may not be visible light and, in such embodiments, the material may be transparent to the type of non-visible that is being used for the shape curing and/or affixing (e.g., ultraviolet (UV) light).

In the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure.

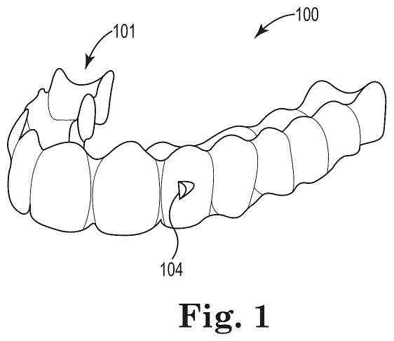

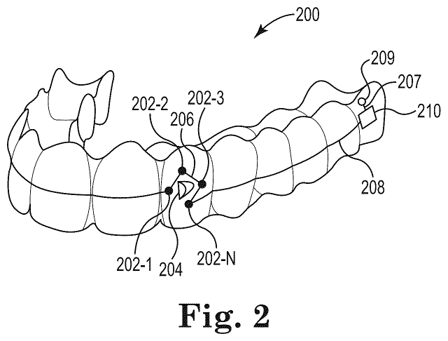

The figures herein follow a numbering convention in which the first digit or digits correspond to the drawing figure number and the remaining digits identify an element or component in the drawing. Similar elements or components between different figures may be identified by the use of similar digits. For example, 104 may reference element “04” in FIG. 1, and a similar element may be referenced as 204 in FIG. 2. Further, as used herein, the designators “M”, “N”, and “P”, with respect to reference numerals in the drawings, indicate that any number of the particular feature so designated can be included.

As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present disclosure, and should not be taken in a limiting sense.

Embodiments of the present disclosure include attachment template trays with pre-fabricated (cured attachments) attachments that have an affixation surface that is pre-coated with light activated glue for affixation of the attachment to the surface of a tooth. The tray is inserted into the patient's mouth, and, in some embodiments, as soon as the tray is fully seated on the patient's teeth, a sensor (e.g., push button (force activated)) activates a light source on the tray. In such an embodiment, the built-in curing light source or associated curing light source tray (e.g., UV/LED) starts the curing process to cure the bonding material.

In some embodiments, the curing light dims or extinguishes after expiration of the predetermined curing period. The patient can then remove the attachment template tray and light source tray, if used. As described herein, the power source and the light source can be integrated with the attachment tray or it can be a modular system with separation between the light source and the attachment (e.g., separate trays for the attachment template and the light source.

As discussed above, in some embodiments, rather than having pre-formed and cured attachments, the attachment tray can be filled with attachment material that can be cured to form the desired attachment shape. And, although the discussion herein generally describes attachments being used on the buccal surfaces of the teeth, it should be noted that embodiments herein can be adapted to work on attachments placed on the lingual surfaces of the teeth as well.

FIG. 1 illustrates an attachment template tray for the placement of an attachment on one of a patient's teeth according to a number of embodiments of the present disclosure. In the embodiment shown in FIG. 1, the attachment template tray 100 includes a body 101 that is formed to receive one or more teeth therein. In the embodiment shown, the body is shaped to receive all of the teeth in the upper jaw of a patient.

The attachment template tray 100 also includes an attachment cavity 104 shaped to form an attachment. The attachment cavity 104 has interior surfaces that are used to form the exterior surfaces of the attachment.

The attachment cavity can be sized to hold a specific amount of attachment formation material that is sufficient to form the desired shaped attachment needed for the treatment plan to treat the orthodontic conditions of a patient. This not only includes an amount sufficient to form the exterior attachment surface shapes defined by the interior surfaces of the attachment cavity, but also sufficient material form an affixation surface that can be used to affix the attachment to the surface of a tooth.

The affixation surface can be a flat surface or can have a shape that matches that of the surface of the tooth to which the affixation surface is to be affixed. A matching surface to that of the tooth can be beneficial as it may allow for a stronger affixation of the attachment and thereby the attachment can be used with higher forces when used in combination with a dental appliance.

Additionally, as discussed herein, some embodiments may use a bonding material to affix the attachment to the surface of a tooth. When sizing the attachment cavity, the size can be calculated to include space for this bonding material.

Further, in some embodiments, the attachment cavity may have a release material (e.g., lubricant, thin film, coating, etc.) provided between the surfaces of the attachment cavity and the material used to form the attachment. Such release material may be beneficial in separating the attachment from the attachment cavity. Any suitable release material may be used to accomplish such functionality. In such embodiments, the size of the attachment cavity may be calculated to accommodate the release material based on an estimate of the amount of space needed to accommodate the release material.

In various embodiments, the attachment cavity may be provided to the user with no attachment, release, or bonding material therein (e.g., may be added by the treatment professional, patient, or other user), may be provided with attachment material therein, or may be provided with release and/or the bonding material provided in the attachment cavity with the material used to form the attachment.

The sizing of the attachment cavity can be determined based on whether a release material is to be used and/or whether a bonding material is going to be used to affix the attachment to the tooth rather than the attachment being affix directly to the tooth surface. As discussed above, the size of the attachment cavity attributable to the release material can be calculated, for example, based on amount of release material to be used and the volume of the type of release material to be used, among other variables.

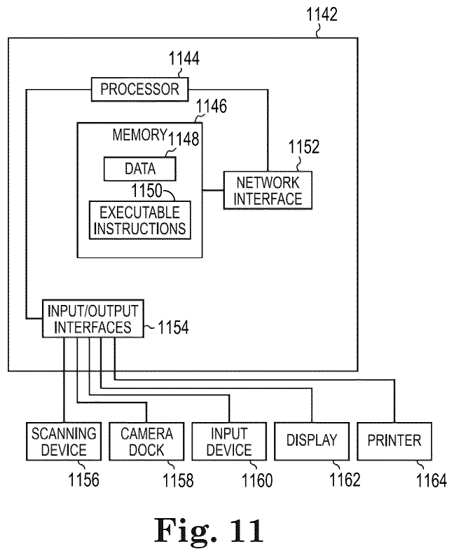

Such calculations can also be made with respect to the attachment material and/or the adhesive material to be used. These calculations can be made by a treatment professional or by executable instructions of a computing device that can be used to design a specific treatment plan for a particular patient or design an attachment template tray, as discussed in more detail with respect to FIG. 11.

One or more of the attachment surfaces will be used to interact with one or more surfaces of the dental appliance and, therefore, the shape, position, and orientation of the one or more surfaces that interact with the dental appliance is important. Accordingly, the attachment template tray is used to more accurately shape, position, and orient the attachment with respect to the tooth surface to which it is to be attached.

In some implementations, a first surface may be utilized through interaction with one or more surfaces of a dental appliance while second surface is not utilized. Then, later in treatment, the second surface is either additionally or alternatively used to interact with one or more surfaces of a dental appliance. In this manner, an attachment can be designed to provided more than one function during the treatment of the patient based on use of different surfaces provided on the attachment.

As shown in FIG. 1, the shape of any of the trays discussed herein can be designed to approximate the shape of one or more teeth of the patient. The more accurately the shape of the attachment template tray approximates the shape of one or more the surfaces of a tooth of a patient, the more accurate the placement of the attachment can be. This is because each tooth surface has unique characteristics (e.g., contours, edges, peaks, valleys, etc.) and if a surface of the tray closely approximates these characteristics, then the surface of the tooth and the surface of the tray can be closely mated to each other (i.e., characteristics are aligned when the tray is placed over the tooth) and this results in more accurate placement of the attachment on the surface of the tooth.

The more characteristics on a tooth that are approximated on the tray, the more accurate the placement of the attachment can be. The more tooth surfaces that are approximated, the more accurate the placement can be. Further, if more teeth on the jaw of a patient are approximated, the accuracy can also be increased in this manner. Accordingly, an embodiment, as shown in FIG. 1, can be very accurate if the shapes of the teeth of the jaw of the patient have been closely approximated by the surfaces of the attachment template tray body 101.

As discussed herein, in some embodiments, the attachment template tray (e.g. clear plastic tray) can have one or more pre-fabricated attachments therein. The attachments can be pre-coated with a light curable adhesive (e.g., an ultra violet (UV) curable adhesive with the light, for example, provided by one or more light emitting diodes (LEDs)).

In some such embodiments, the tray can, for example, be stored in a light blocking bag (visible light or other light depending on what light is used to cure and/or adhere the attachment) for transportation and storage. In such embodiments, the user can open the bag, insert the tray into the patient's mouth, insert one or more light sources, if not provided on the tray (as shown in some embodiments herein), wait for a period of time (e.g., 3 minutes) for the adhesive to cure, and then remove both the attachment template tray and one or more light sources, if separately provided. The one or more attachments will then be fixed to the one or more tooth surfaces for the duration of the treatment period that they are needed.

FIG. 2 illustrates an attachment template tray having a plurality of light sources thereon according to a number of embodiments of the present disclosure. In the embodiment of FIG. 2, the tray 200 includes a number of light sources 202-1, 202-2, 202-3, 202-N (also referred to generally as light sources 202) attached to the tray 200. In some embodiments, light sources can be attached to the surface of the tray. Light sources can also be embedded within the material forming the attachment template tray 200. As used herein, the term “embedded” means that a light source is fixed into the material forming the tray rather than being attached onto the material.

A light source and/or power source can be encapsulated within the attachment template tray body. As used herein, “encapsulated” means that the material used to form the tray completely surrounds the light source/power source in three dimensions. Such embodiments can be beneficial as the light source/power source is protected, for example, from saliva within the patient's mouth that could damage the light source. Additionally, when the light source/power source is encapsulated, it does not need to be biocompatible which may reduce cost for manufacture and the time for clearance of the tray by regulatory agencies, in some instances.

The embodiment of FIG. 2 also includes one or more power sources 210 to provide power to the light sources 202 via an electrical connection, such as wire 208. In some embodiments, the light sources 202 can be connected to each other via wires 206. This can allow for one power source to power multiple or all of the light sources and can allow for the light sources to be operated together based, for example, upon switching the supply of power to them on and off.

For instance, multiple light sources can be connected in series to a power source and, in this manner, when the power source is turned on, all of the light sources turn on. However, in other embodiments, the attachment template tray body includes multiple power sources and each of multiple light sources is connected to a different power source. In this manner, the light sources can be operated independently and the power supply can last longer, among other benefits of such an implementation.

Light sources can also be powered in groups. For example, a first group of one or more light sources can be powered by a first power source and a second group of one or more light sources can be powered by a second light source.

An embodiment such as that shown in FIG. 2 can be beneficial in many ways. For example, the light sources are provided on the attachment template tray and, as such, the treatment professional does not need to hold the light sources with a hand, thereby, allowing the treatment professional to do other things with that hand while a curing process is being accomplished.

Additionally, the light sources are likely located closer to the attachment than would be possible with a hand held light source. This is particularly the case where the light sources are embedded within the tray, since a hand held light source could not be within the tray material as an embedded light source could be.

Further, another benefit is that multiple light sources can be used in some embodiments which would be very difficult to accomplish with hand held light sources. In such embodiments, such as that shown in FIG. 2, the light sources 202 may be spaced around the attachment cavity 204 which may potentially provide exposure to more surfaces of the attachment than the use of a hand held light source could provide.

In some embodiments, the one or more light sources can be automatically activated when the tray is seated on the teeth. This can be accomplished, for example, by the placement of one or more sensors 209 in the body of or on the surface of the tray, for example, in connection with the power source 210 (e.g., via electrical connection, such as wire 207), that will sense the placement of the tray 200 in the mouth of the patient.

This can be sensed, for example, by contact (or pressure) of the teeth against the tray. Any suitable sensor can be used to activate the one or more light sources and it can be positioned in any suitable location on the tray. For example, suitable sensors include, but are not limited to, temperature, humidity, light, moisture, chemical, etc.

In some embodiments, the lights can be manually activated. This can be accomplished, for example, by having the sensor be actuated by interaction with a user (button that can be pressed or other suitable actuator). In some embodiments, the activation can be accomplished by connecting a power source to one or more light sources (e.g., connecting a battery to create an active circuit between a battery and a light source).

In some embodiments, the activation of the one or more light sources can be for a duration of time that is suitable for the forming and/or affixing process to be completed. For example, the one or more light sources could be activated for a period of 3 minutes and then automatically turned off after that duration has passed.

This can be beneficial, for example, where a patient places the tray in their mouth and can know to remove it after the light sources turn off. In such an embodiment, if UV or other non-visible light sources are used to form/affix the attachment, a visible light source may also be used to help indicate to a user (patient, treatment professional, etc.) when the tray should be removed.

In an example embodiment, an attachment template tray for creating and placing attachments used in moving teeth of a patient includes an attachment template tray body having a first surface shaped to conform to the contours of exterior surfaces of teeth of a patient and including a portion of the first surface that provides a cavity to form the exterior surfaces of an attachment that is to be attached to the exterior surface of one of the teeth. Such an embodiment also includes an integrated set of multiple light sources on the body of the attachment template tray, wherein the multiple light sources are located at positions proximate to the cavity for the formation of the attachment.

As discussed herein, light can be used to cure an attachment and/or affix the attachment to the surface of a tooth. As such, at least a portion of the body can be made of a light transmissive material. This allows for light from a light source to pass through the material of the body to cure a light curable material that is, for example, in contact with the tooth. In some embodiments, at least a portion of the body is made of a transparent material that is light transmissive to visible light. Additionally, in some embodiments, at least a portion of the attachment template tray body is made of nonvisible light transmissive material (e.g., a UV light transmissive material) to allow nonvisible light from the multiple light sources to cure a nonvisible light curable material that forms the attachment and/or that is in contact with one of the multiple teeth.

In some embodiments, the tray can include multiple attachments that each has one or more light sources near its respective attachment cavity. These light sources can be powered by their own power source or multiple sources or can receive power from a power source that provides power to one or more other light sources. Additionally, the multiple attachments and their corresponding attachment cavities can be located to affix the attachments on the same tooth or different teeth.

Another example embodiment based on FIG. 2 can include the following: an attachment template tray for creating and placing attachments used in moving teeth of a patient, having an attachment template tray body with a first surface shaped to form multiple tooth shapes that conform to the contours of exterior surfaces of multiple teeth of a patient and including a portion of the first surface that provides a cavity to form the exterior surfaces of an attachment that is to be attached to the exterior surface of one of the teeth. The embodiment also includes an integrated power source and a set of light sources attached to the body of the attachment template tray. In some embodiments, a set of light sources can include a single light source.

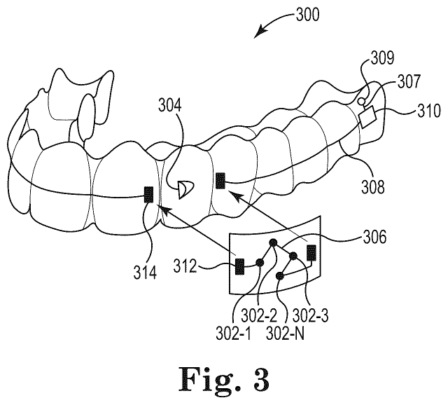

FIG. 3 illustrates an attachment template tray system having a tray with contacts and a lighting component that attaches to the tray according to a number of embodiments of the present disclosure. In the embodiment illustrated in FIG. 3, the tray 300 includes an attachment cavity 304, a power source 310, sensor 309, electrical connection of the sensor to the power source 307, and one or more electrical connections 308 connecting the power source to a number of electrical contacts 314.

The embodiment of FIG. 3, includes multiple electrical contact surfaces 314. Each of the electrical contact surfaces is configured to contact with one of a corresponding number of multiple electrical contacts 312 on a light source element that is to be attached to the attachment template tray body.

The light source element can be attached to the body by any suitable mechanism. For example, the light source element may be attached via adhesive to an exterior surface of the attachment template tray body.

The location of the placement of the light source element can be any suitable location on the tray 300. In the embodiment shown in FIG. 3, the light source element is to be placed such that the light sources 302-1, 302-2, 302-3, 302-N are positioned around the cavity 314 of the attachment.

As shown in FIG. 3, the light sources can be connected in series between the electrical contacts (e.g., via wires 306). However, in some embodiments, some or all of the light sources could, additionally or alternatively, be connected in parallel between the electrical contacts.

In some embodiments, the light source element may have an aperture formed therein such that the cavity can be positioned in the aperture. This may be beneficial, for example, as it would allow the light source element to better conform to the outer surface of the tray.

Further, the light source element can be constructed of any suitable material. Examples of characteristics of suitable materials can, for example, include materials that are flexible, light transmissive, and/or biocompatible.

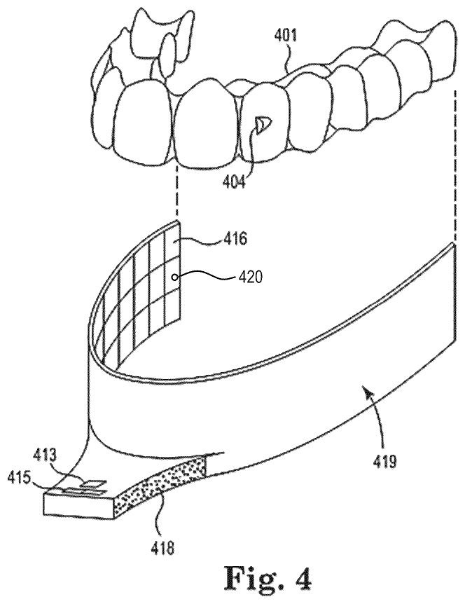

FIG. 4 illustrates an attachment template tray system having a tray and a lighting component that is placed around the tray according to a number of embodiments of the present disclosure. In the embodiment of FIG. 4, the lighting component 419 is a separate tray that is sized to be placed around the attachment template tray body 401.

Similarly, to the embodiments of FIGS. 2 and 3, the lighting component 419 can have one or more power sources. The power sources are not shown in FIG. 4, but the understanding of how they work and their placement in the material of the lighting component or on the surface of the lighting component can be understood from the discussion of FIGS. 2 and 3.

The lighting component can have one or more power sources and the sources can be one use (once the power source is depleted, it cannot be replaced), rechargeable, or replaceable (the power source can be removed and replaced with a new one, such as the removal and replacement of a battery). In addition, the power source can be placed on the surface of the lighting component, embedded in the material forming the lighting component, or encapsulated within the material forming the lighting component.

The lighting component can have one or more light sources 416 thereon. The one or more light sources can be arranged in any suitable arrangement on the lighting component. For example, in the embodiment shown in FIG. 4, each of the rectangular shapes 416 can be a separate light source.

The light sources can be organized in an ordered pattern (such as that shown in FIG. 4). Any suitable organized pattern can be utilized. The light sources could also be positioned in a random arrangement, if desired.

Further, in some embodiments, the light sources could be specifically positioned based on the location of the attachment cavity. For example, the cavity position could be ascertained (via treatment planning of the orthodontic treatment of the patient's orthodontic conditions) and then the lighting component could be designed such that the light sources provided on the lighting component are positioned to be proximate to the attachment cavity when the lighting component is placed proximate to the attachment template tray. The ascertaining of the attachment cavity position can be accomplished, for example, by a treatment professional or via computer executable instructions that can be used to design a specific treatment plan for a patient.

In some embodiments, the lighting component can have on large light source that applies light to the entire attachment template tray. Such an embodiment may be beneficial to provide a uniform amount of illumination to multiple attachment cavities for the curing of the attachment and/or the adhering of multiple attachments to the teeth of the patient.

In some embodiments, the light sources can operate together and, in other embodiments, the light sources can be controlled independently. This can be accomplished in an suitable manner, for example, based on which power source is activated (the insertion of a battery to complete a circuit with one or more light sources to activate the light sources).

For example, one power source may be connected to one or more light sources that illuminate a first area of the attachment template tray and a second power source may be connected to one or more light sources that illuminate a second, different area of the attachment template tray. This may be beneficial in embodiments having multiple attachment cavities and wherein, the user may not be prepared to affix multiple attachments at the same time.

The lighting component 419 may also have a handle 418 to aid in the positioning of the lighting component in the mouth of the patient such that it is also in the correct position relative to the attachment template tray. In placement of the lighting component 419, the attachment template tray body 401 is placed on the teeth of the patient with the attachment cavity 404 positioned accurately on the surface of the tooth to which the attachment is to be placed. The lighting component 419 is positioned proximate to the outer buccal surface of the attachment template tray such that it is close enough for the light emanating from the one or more light sources can cure the attachment material and/or bonding material to affix the attachment to the surface of the desired tooth.

In some embodiments, the handle can include the power source 413 and/or or controls 415 for turning on and off the light sources. For example, the handle can have an integrated circuit or processor that can be used to control the light sources by a user (e.g., via a user interface, such as a push button or other suitable interface for controlling the light sources).

Provided below are some examples of embodiments that are related to the embodiment shown in FIG. 4. In one such example, an attachment template tray can have cavities with pre-formed attachment material therein or material can be added into the cavity. The attachment template tray can be placed on the patient's teeth and a light source tray is positioned on the attachment template tray to cure the attachment material or bond a bonding material on the attachment to the surface of a tooth.

Further, in a system embodiment example for creating and placing attachments used in moving teeth of a patient, the system includes an attachment template tray body having a first surface shaped to conform to the contours of exterior surfaces of teeth of a patient and including a portion of the first surface that provides a cavity to form the exterior surfaces of an attachment that is to be attached to the exterior surface of one of the teeth and a light source tray having an integrated light source, wherein the power source is electrically connected to the light source and provides power to the light source and wherein the tray has an inner surface that is larger than an exterior surface of the attachment template tray body such that the interior surface of the tray can be positioned adjacent the exterior surface of the attachment template tray.

The light source tray can have an inner surface that has a shape that is a corresponding shape to that of an exterior surface of the attachment template tray body such that the interior surface of the light source tray will mate with the exterior surface of the attachment template tray. In this manner, the shape of the outside surface of the attachment can be formed and/or affixed to the surface of the tooth. It should be noted that the shape of the attachments formed in the embodiments of the present disclosure can be a standard attachment shape or a specialized shape determined based on characteristics of the patient, type of attachment material, and/or the forces needed to move one or more teeth of the patient.

As with other embodiment discussed herein, in these embodiments, at least a portion of the body can be made of a light transmissive material to allow light from the light source to cure a light curable material in contact with the tooth. For example, at least a portion of the body can be made of a transparent material that is transparent to visible light and/or ultraviolet light, among other wavelengths of light.

As discussed above, the tray can include an activation mechanism that actuates the power source when actuated by a user. For example, the tray can include an activation mechanism (e.g., 240) that actuates the power source when the tray is within a threshold distance of the attachment template tray. The threshold distance can be any suitable distance and can be determined, for instance, via the use of a photo diode sensor among other sensor types that can trigger activation of the power source.

The attachment template tray can include an activation mechanism that signals to the power source to actuate when the tray is within a threshold distance of the attachment template tray. This, for example, can be accomplished by a wireless transmitter and a receiver sensor configured to receive a signal from the wireless transmitter.

In another embodiment, a light source tray for use in dental treatments includes a light source tray body shaped to be positioned within the mouth of a patient and having at least one integrated light source and at least one power source therein, wherein the power source is electrically connected to the light source and provides power to the light source. In this embodiment, the tray has an inner surface that is shaped to conform around a buccal surface of a patient's tooth. As shown in FIG. 4, the light source tray can have an inner surface that can conform around the buccal surfaces of more than one tooth and, in some embodiments, can conform around the buccal surfaces of all teeth along one or both jaws of a patient.

In this manner, the light source tray can be positioned close to where the attachment will be positioned for attachment to the buccal surface of a tooth of the patient. Where the light source tray has an inner surface that can conform around the buccal surfaces of more than one tooth or conforms around the buccal surfaces of all teeth along one or both jaws of a patient, multiple attachments can be attached at the same time and can be affixed to different jaws.

The light source tray has an inner surface that is larger than an exterior surface of an attachment template tray body for placement of an attachment that is to be secured to a tooth of a patient and wherein the interior surface of the light source tray can be positioned adjacent to the exterior surface of the attachment template tray. In this manner, the light source tray can be positioned in the mouth of the patient with the attachment template tray, in some implementations.

As discussed herein, the at least one light source and/or power source can be encapsulated within the tray body. This can be done to protect the light or power sources from damage due to exposure from elements within the mouth of the patient.

In such an embodiment, the tray body includes an actuation mechanism to actuate the power source. This can, for example, be accomplished by an activation mechanism that actuates the power source when a sensor, connected to the actuation mechanism, senses a predefined characteristic. As discussed herein, the predefined characteristic can, for example, be temperature, light (via a light sensor), humidity, moisture, the presence of a chemical, or other suitable characteristic that can be sensed. Further, the activation mechanism can be used to actuate a power source when a sensor, connected to the actuation mechanism, is in contact with a surface of the mouth of the patient and/or a fluid therein.

In another embodiment, a system for creating and placing attachments used in moving teeth of a patient includes an attachment template tray body having a first surface that provides a cavity to form the exterior surfaces of an attachment that is to be attached to the exterior surface of one of the teeth and a light source tray having integrated light source, power source, and actuation mechanism on the body of the attachment template tray, wherein the power source provides power to the light source when the actuation mechanism is actuated.

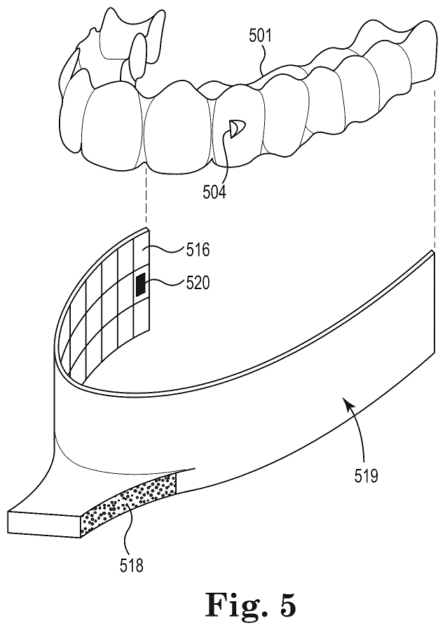

FIG. 5 illustrates another attachment template tray system having an attachment template tray and a lighting component that is placed around the tray according to a number of embodiments of the present disclosure. In some embodiments, such as the embodiment of FIG. 5, the light sources can be automatically actuated when a sensor senses suitable conditions to turn on the light source. For example, in FIG. 5, an attachment template tray body 501 having an attachment cavity 504 therein is positioned in the mouth of a patient and a lighting component 519 having a handle 518 therein is positioned in the mouth of the patient, over the attachment template tray body 501.

The light sources 516 are activated when a sensor 520 is activated by a characteristic in the patient's mouth. For example, the sensor can be a photo diode and can detect the when a tooth is in proximity of the photodiode. As discussed above, any suitable threshold proximity can be used for such functionality.

In some treatment plans for the treatment of orthodontic conditions in patients, it may be necessary to use different attachments to accomplish the goals of the treatment plan. Traditionally, this meant that the attachment that was affixed to the surface of the tooth would have to be removed (by scraping the attachment free with a tool or grinding it off of the tooth surface with a grinding tool). Such removal can potentially harm the surface of the tooth, requires expertise by the treatment professional, and cannot be effectively accomplished by an at home user. Accordingly, as discussed below, changeable or degradable attachments of the present disclosure may be beneficial in such situations.

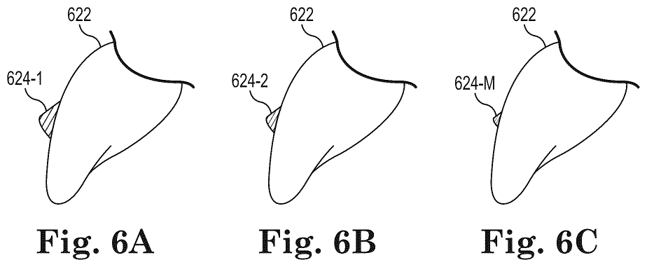

FIGS. 6A-6C illustrate an attachment that changes shape over a period of time according to a number of embodiments of the present disclosure. The embodiment of FIGS. 6A-6C illustrate a dental attachment that changes shape over time. In embodiments herein, a treatment plan can be devised based on the known degradation characteristics of a particular material used to form the attachment or the attachment can be designed with certain features that will emerge as the outer material of the attachment degrades and is detached from the attachment body. Further, in some embodiments, the attachment can be formed from multiple materials where one material degrades faster than one or more other materials or where one or more materials degrade and one or more materials do not. In such implementations, the attachment changes shape over time and a treatment plan can continue to use an attachment where previously a nonchangeable attachment would need to be removed.

In the embodiment illustrated in FIGS. 6A-6C, an attachment is initially placed on the patient's tooth 622 at a first point in time and has an active surface 624-1 with a first size. As used herein, an “active surface” of an attachment is a surface used to interact with one or more surfaces of a dental appliance to assist the appliance in providing force to move one or more teeth of a patient. And, as used herein, a surface that is provided on an attachment that is intended to be used to interact with one or more surfaces of a dental appliance to assist the appliance in providing force to move one or more teeth of a patient, but is currently not being utilized is considered to be a “nonactive surface”.

With respect to the embodiment shown in FIGS. 6A-6C, as the treatment progresses over time, the attachment begins to degrade and becomes smaller as shown in FIG. 6B at a second, later point in time. As can be seen in FIG. 6B, the active surface 624-2 is smaller than it originally was in at 624-1 in FIG. 6A. However, the active surface 624-2 may still be usable for interacting with one or more surfaces of a dental appliance. Accordingly, although it is getting smaller, it can still be usable.

In FIG. 6C, the attachment continues to degrade and becomes even smaller as shown in FIG. 6C at a third, later point in time. As can be seen in FIG. 6C, the active surface 624-M is smaller than it originally was in at 624-1 in FIG. 6A and at 624-2 of FIG. 6B. However, the active surface 624-M may still be usable for interacting with one or more surfaces of a dental appliance even in its smaller state.

In some embodiments, the attachment will continue to degrade until it is completely gone. In some such embodiments, it may be possible to also utilize a degradable bonding material that will also degrade until it is gone leaving the patient with no evidence that an attachment had been placed on the tooth.

This can be beneficial for a number of reasons. For example, there is no visit to a treatment professional needed, saving the patient time and money and making the treatment more convenient for the patient, especially for the at home treatment patient, among other benefits.

A degradable attachment can, for example, be made with a biodegradable material that can be designed to degrade over a predetermined time period (e.g., twelve month period) to an end condition at the end of that period which is no longer usable as an attachment. Such degradation qualities of a material can, for example, be ascertained through experimentation with the material in conditions similar to that existing in the mouth of a patient or through patient trials, among other methods.

In some embodiments, depending on the treatment length, a different biodegradable composite material can be used for different attachments within the same patient. For example, one attachment may be needed for a period of three weeks where another attachment may be needed for six months. The degradable materials used may be different materials to accommodate such differences in usage.

Further, it may be that the conditions within one person's mouth or one area within the mouth of a patient will be different than another, causing a particular material to degrade more quickly than in another patient's mouth or another area within a patient's mouth. In such situations, the characteristics of a patient's mouth can be determined (e.g., temperature, humidity, moisture, chemical composition) and the type of degradable material can be selected based on these characteristics and the amount of time the attachment is to be used.

Additionally, as discussed above, in some implementations, a first surface of the attachment may be utilized through interaction with one or more surfaces of a dental appliance while a second surface is not utilized. Then, later in treatment, the second surface is either additionally or alternatively used to interact with one or more surfaces of a dental appliance.

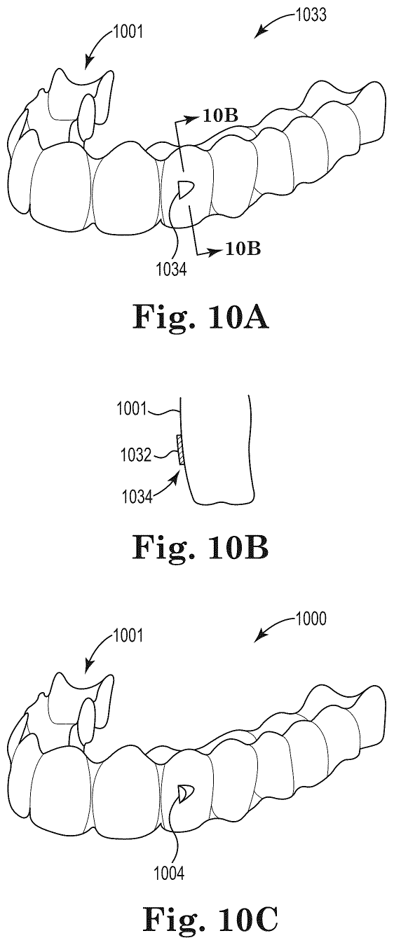

In this manner, an attachment can be designed to provide more than one function during the treatment of the patient based on use of different surfaces provided on the attachment. In some degradable embodiments of the present disclosure, the second or other surfaces, can be hidden under the surface of the attachment and can emerge to become usable once the attachment degrades to a certain extent. Such embodiments will be discussed in more detail with respect to FIG. 9.

Degradable materials can be of any suitable type. For example, some suitable materials include materials that degrade based on characteristics present within the mouth of the patient, such as temperature, humidity, moisture, and/or chemical composition. Some embodiments can be degraded based on catalysts introduced into the mouth of the patient. Some suitable examples of catalysts include chemicals, liquids having particular characteristics, light of a particular wavelength or frequency, among other suitable catalysts.

Examples of biodegradable attachment materials that may be used to form a degradable attachment include the following: Polyhydroxyalkanoates (PHAs) such as poly-3-hydroxybutyrate (PHB), polyhydroxyvalerate (PHV) and polyhydroxyhexanoate (PHH); polylactic acid (PLA); polybutylene succinate (PBS), polycaprolactone (PCL); polyanhydrides; polyvinyl alcohol; starch derivatives; and cellulose esters such as cellulose acetate and nitrocellulose and their derivatives (celluloid).

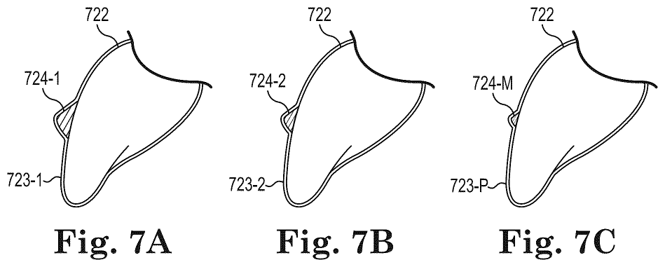

FIGS. 7A-7C illustrate a series of dental appliances designed to work in conjunction with an attachment that changes shape over a period of time according to a number of embodiments of the present disclosure. In this embodiment, a treatment plan can be determined that utilizes multiple dental appliances designed specifically for a particular patient based upon the physiology of the patient's teeth and mouth (each illustration 7A, 7B, and 7C, shows a different dental appliance that can, for example, be part of a treatment plan to move one or more of a patient's teeth), each having a portion shaped to have surfaces that either accommodate (don't interact to provide force) or interact with the attachment surfaces to provide force to move one or more teeth of the patient. In this embodiment, the dental appliance are placed over the outer surface of the tooth 722 and the outer surfaces of the attachments (721, generally) that are not affixed to the tooth.

As the attachment degrades from its original size at 724-1, to its smaller sizes at 724-2 and at 724-M, the portion of each dental appliance designed to be placed over the attachment (723-1, 723-2, 723-P, respectively) is sized based on the point in time to which that particular dental appliance is to be used and the corresponding estimated size of the attachment at that point in time. The estimation can be accomplished in any suitable manner.

For example, if the rate of degradation is known, then the shape and size of the attachment can be estimated at any particular point in time during a treatment. Further, if the characteristics of physiology of the patient's mouth are known, as discussed above, these characteristics can be used to further precision the estimate.

Alternatively, in some embodiments, the actual size of the attachment can be determined and the corresponding dental appliance to be used for that point in time can be designed based on the determined size of the attachment. Such a determination could be accomplished, for example, by taking a mold of the attachment or the patient's tooth or jaw with the attachment thereon, taking a scan using an oral scanning device, and/or taking photos of the attachment, tooth or jaw with the attachment thereon, among other calculation methods.

In some embodiments, the attachment may degrade to a size that is no longer usable to interact with the dental appliance to provide force. At such a time, in embodiments similar to that shown in FIGS. 7A, 7B, and 7C, the dental appliances can still be designed with a portion that will fit over the attachment and, in that manner, the proper fit of the dental appliance can be maintained.

Again, the estimation of the size and/or shape of the attachment can be estimated as described above. Further, in some embodiments, the sizing of this portion of the dental appliance can be oversized such that it does not contact one or more surfaces of the attachment.

This can be beneficial in a number of ways. For example, an oversized portion can reduce the likelihood of unintended interaction of the attachment with the dental appliance can reduce the need for accuracy with respect to the estimate of the size and/or shape of the attachment, among other benefits.

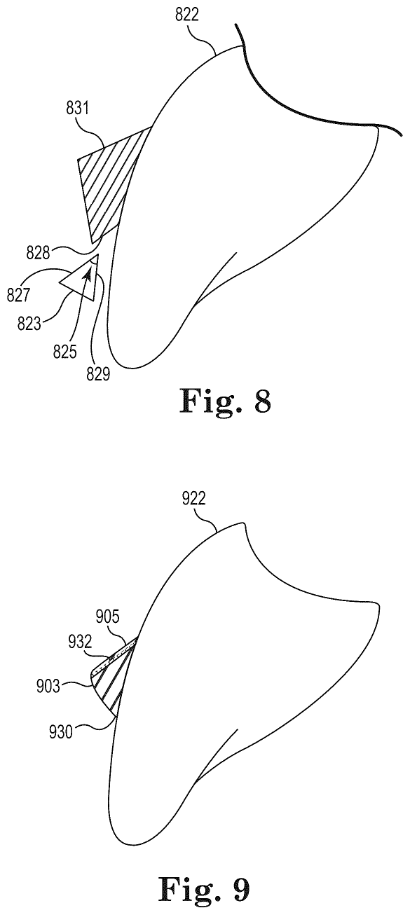

FIG. 8 illustrates a concept wherein a shear force can be provided by a removal appliance to remove the attachment from a tooth of a patient according to a number of embodiments of the present disclosure. In such an embodiment, the attachment has an active surface 831 that interacts with an engagement surface of a dental appliance, but the attachment also includes a removal surface 828 to allow for easier removal of the attachment by application of a shear force by a removal tool, such as removal tool 823 of FIG. 8.

The shear force exerted is greater than the retention force of the bond that holds the attachment to the surface of the tooth. In such a manner, when the shear force is provided, it overcomes the retention force and the attachment releases from the surface of the tooth.

The shear force and retention force can be estimated or determined by testing and, therefore, appropriate removal tool shapes can be determined based on the amount of shear force needed to overcome the retention force.

For example, the removal tool 823 can be used to pry the attachment from for the tooth by being placed between the surface of the tooth 822 and the shear surface 828. In some embodiments, the removal tool can be a wedge shaped tool with the angle 825 of the surfaces (827, 829) of the wedge being larger than the angle between the shear surface 828 and the surface of the tooth 822.

In this manner, when positioned between the shear surface and surface of the tooth, the angled surfaces 827 and 829 of the wedge will exert force on shear surface 828 and surface of the tooth 822. This exertion of force will pry the attachment from the tooth's surface.

Embodiments having the removal features as discussed herein can be utilized on non-degradable or degradable attachments. For example, a feature, such as that shown in FIG. 8 can be utilized on a degradable attachment, such as that shown in FIGS. 6A-7C.

As discussed above, in such an embodiment, the shear force needed to remove the attachment is greater than the retention force used to bond the attachment to the surface of the tooth. These forces can be calculated and/or estimated (e.g., via a computing system like that of FIG. 11) based on the characteristics of the bonding or attachment material (material type, retention force for attachment to a tooth surface) used to bond the attachment to the surface of the tooth, the characteristics of the shear surface (material type, shape of the surface, angle of the surface, etc.), and/or the characteristics of the shear tool (material type, mechanism for generating shear force, angle of wedge surfaces if wedge is used, etc.).

Once the retention force is known, the shear force needed can be determined. The shape of the attachment can then be designed to create the suitable shear force through use of a known shear tool or through use of a tool designed to provide a certain shear force when used in conjunction with a specifically designed attachment shape. Alternatively, attachment shapes can be predesigned and a shape can be selected based on the retention force needed, the implementation desired, the shear tool available, or other suitable selection criteria.

FIG. 9 illustrates an embodiment with a nonactive engagement surface hidden under the outer surface of the attachment according to a number of embodiments of the present disclosure. In the embodiment of FIG. 9, the attachment 903 is bonded to the surface of the tooth 922 at 930 and has an active engagement surface 905 on the outer surface of the attachment 903. The embodiment also has a hidden nonactive engagement surface 932 hidden under the outer surface of the attachment 903.

As discussed herein, degradation can occur due to exposure to elements within the mouth of the patient or via application of a catalyst. Temperature, humidity, moisture, or chemical composition are example of elements within the mouth of a patient that can be utilized to affect degradation. Further, examples of catalysts can be chemicals, liquids having particular characteristics, light of a particular wavelength or frequency, among other suitable catalysts.

Provided below are examples of embodiments of the present disclosure related to FIG. 9. In such embodiments, the attachment and/or bonding material can be made of degradable material that is designed to degrade over a particular period.

In one example embodiment, a dental attachment for affixing to a surface of a tooth of a patient and for engagement with a surface of a dental appliance includes a dental attachment body having a first engagement surface thereon, wherein the first engagement surface is shaped to work in combination with an engagement surface on the dental appliance to provide a force vector that is applied to one or more teeth of a patient, and wherein the body includes a second engagement surface hidden beneath an exterior surface of the body. In this embodiment, the first engagement surface is considered an active surface and the second engagement surface is considered a nonactive surface.

In such an embodiment, at least a portion of the exterior surface of the body is removable to uncover the hidden second engagement surface. This can allow the attachment to be used for more than one purpose.

In the embodiment shown in FIG. 9, the hidden surface 932 is generally parallel to the active engagement surface 905. However, the hidden surface can be at any angle as referenced in three dimensions with respect to an active engagement surface.

A nonactive (e.g., second) engagement surface is shaped to work in combination with an engagement surface on a dental appliance to provide a force vector that is applied to one or more teeth of a patient that is different in magnitude of the force provided than that of the force vector of the active (e.g., first) engagement surface. Further, the nonactive engagement surface can be shaped to work in combination with an engagement surface on a dental appliance to provide a force vector that is applied to one or more teeth of a patient that is different in direction of the force provided than that of the force vector of the active engagement surface. In this manner, the treatment plan can use the modified attachment shape to provide different magnitude and/or direction of force to move one or more teeth without the removal and replacement of the original attachment.

In the embodiment shown in FIG. 9, the nonactive engagement surface 932 is made of a different material 930 than the rest of the body of the attachment. For example, the nonactive engagement surface can be made from a nondegradable material or of a material that degrades less than the rest of the body, in some embodiments. This can allow the nonactive engagement surface to emerge and be usable for the duration of the period of treatment wherein the attachment is to be utilized.

Such an embodiment may also be accomplished wherein the body includes two layers of material with the first layer of material including the active engagement surface and the second layer of material including the nonactive engagement surface is made of a different material than the rest of the body of the attachment. In such an embodiment, the active engagement surface may be made from the same material as the body of the attachment or may be made from a third material. In some embodiments, the active and nonactive engagement surfaces may be made from the same material, but the rest of the body is made from a different material. In such an implementation, the body may degrade such that the active engagement surface comes loose from rest of the body of the attachment.

Additionally, in some embodiments, the active engagement surface is on a first layer and the nonactive engagement surface is part of a second layer. In such an embodiment, the first layer is removable from the second layer of material to uncover the nonactive engagement surface.

In some embodiments, the attachment also includes a release layer on the nonactive engagement surface that can be released to remove the portion of the body between the second engagement surface and the exterior surface to uncover the second engagement surface. For example, a releasable material can be provided on surface 932 of FIG. 9 to release surface 905. The release layer can be a degradable material where the rest of the body is not degradable or degrades more than the rest of the body or can be responsive to one or more elements on the mouth of the patient and/or a catalyst where the interaction with the element/catalyst releases the release layer such that the first surface or layer detaches from the first surface or layer.

In another example embodiment, a dental attachment for affixing to a surface of a tooth of a patient and for engagement with a surface of a dental appliance includes a dental attachment body having a first exterior surface with a active engagement surface thereon, wherein the active engagement surface is shaped to work in combination with an engagement surface on the dental appliance to provide a force vector that is applied to one or more teeth of a patient, and wherein the body includes a nonactive engagement surface hidden beneath the first exterior surface of the body.

In some embodiments, the body includes multiple layers of material with a first layer of material including the active engagement surface and a second layer of material including the nonactive engagement surface. In such implementations, embodiments can be created with more than two layers and potentially more than two engagement surfaces. In this manner, the attachment can be used for more than two treatment periods.

Additionally, in some embodiments, the layers are on top of each other, but in others, one layer may be on one side of the attachment and another layer may be on another side. Further, the layers may be degraded or released using different elements and/or catalysts. These elements/catalysts can be considered a release agent for releasing a release layer.

In some embodiments, the first layer is removable from the second layer of material to uncover a second exterior surface and the nonactive engagement surface. This may be the case where a first material degrades at a first rate and a second material degrades at a second rate. The attachment can also include a release layer between the first layer and second layer that can be released to remove the first layer from the attachment body and thereby uncovering the second exterior surface and the nonactive engagement surface. The exterior surface of the second material can be considered the second exterior surface.

In another embodiment, a dental appliance system having a dental attachment for affixing to a surface of a tooth of a patient and for engagement with a surface of a dental appliance includes a dental appliance body having a first surface shaped to conform to the contours of exterior surfaces of teeth of a patient and including a portion of the first surface that provides a first engagement surface on a dental attachment that is to be attached to the exterior surface of one of the teeth and the dental attachment having a body with a first engagement surface thereon, wherein the first engagement surface is shaped to work in combination with the engagement surface on the dental appliance to provide a force vector that is applied to one or more teeth of a patient, and wherein the body includes a second engagement surface hidden beneath an exterior surface of the body.

As discussed above, in such an embodiment, in order to expose the second engagement surface, the dental attachment can also include a release layer on the second engagement surface that can be released to remove the portion of the body between the second engagement surface and the exterior surface to uncover the second engagement surface. This can be accomplished, for example, by having the release layer release from the second engagement surface through interaction with a particular wavelength or range of wavelengths of radiation or interaction with a solvent, among other release agents.

The attachment embodiments disclosed herein (e.g., degradable attachments, attachments having special removal surfaces, etc.) can be affixed to a tooth of a patient through use of the light source techniques disclosed herein. For example an embodiment such as that shown in FIG. 6A-9, 10D, or 10E can be affixed to a tooth of the patient using a light providing embodiment such as those shown in FIGS. 2-5. Further, the affixation concepts provided herein can also be used to affix standard attachment to a surface of a patient's tooth.

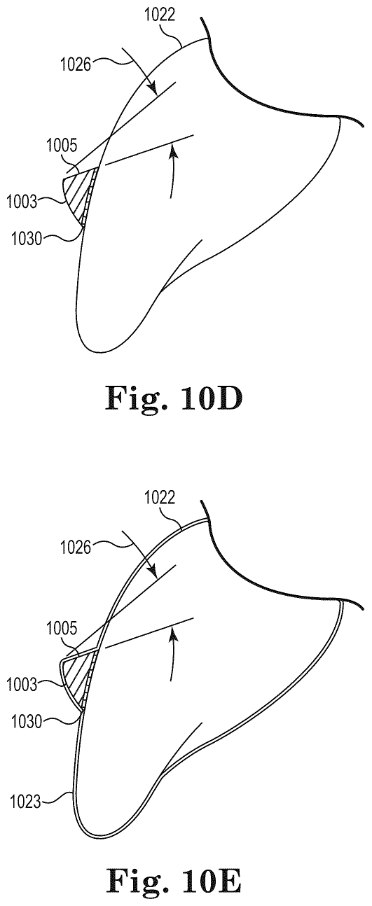

FIGS. 10A-10E illustrate an embodiment of a dental attachment affixing system according to a number of embodiments of the present disclosure. In some embodiments, the surface of the tooth will need to be etched before the attachment can be affixed to the surface of the tooth. The etching techniques disclosed herein can be used to assist in affixing standard attachments, attachments with special removal surfaces, or degradable attachments as discussed herein and can be utilized prior to using the light source embodiments discussed herein.

Etching the tooth can be beneficial in strengthening the bond between the surface of the attachment and the surface of the tooth. This is because the action of etching makes the surface of the tooth a little rougher which provides more surface area onto which to affix the attachment.

In FIGS. 10A and 10B, an etch template tray is illustrated. In FIG. 10A, the etch template tray 1033 includes a body 1001 that is formed to receive one or more teeth therein. In the embodiment shown, the body is shaped to receive all of the teeth in the upper jaw of a patient, although the embodiments are not limited to the upper jaw or to receive all teeth.

As can be seen in FIG. 10B, the etch template tray body 1001 also includes an etch cavity 1034 shaped to hold an etch material 1032 therein. The etch material can be any suitable material that can be used for etching the surface of the tooth. Additionally, the shape of the etch area can be sized smaller, the same size, or larger than the affixation surface of the attachment to be affixed to the surface of the tooth.

Once the surface of the tooth is etched, an attachment template tray like that shown in FIG. 1 can be placed over one or more teeth of the patient. This is shown in FIG. 100 where the attachment template tray 1000 includes a body 1001 that is formed to receive one or more teeth therein.

The attachment template tray 1000 also includes an attachment cavity 1004 shaped to form an attachment. As shown in FIG. 1, the attachment cavity 1004 has interior surfaces that are used to form the exterior surfaces of the attachment.

Once affixed, the attachment 1003 is shown in FIG. 10D affixed to the surface of tooth 1022. The attachment is affixed to the surface of the tooth with a bonding material 1030, as discussed elsewhere herein.

In some embodiments, the bonding material can be an adhesive material that can be weakened or dissipated to release the attachment from the surface of the tooth. For example, a UV curable adhesive can be chemically designed to degrade at the treatment length so the bonding strength between attachment and the tooth surface will diminish over the treatment period. When the bonding strength is low enough, the attachment will release from the surface of the tooth. In some embodiments, a removal tool can be used. In such embodiments, the removal tool can have a low shear force since the retention force is lower due to the degradation of the bonding material.

In some embodiments, the adhesive on tooth surface will degrade so no residue is left on the tooth surface. Examples of suitable degradable adhesives include chemicals, such as an adhesive formulation containing soybean based adhesive, starch based adhesive, polycaprolactone (PCL) polyesters, and polylactic acid (PLC).

FIG. 10D also has an engagement surface 1005 for engagement of the attachment with an engagement surface of a dental appliance. The angle 1026 of the engagement surface can be used to remove the attachment from the tooth. This can be accomplished with a removal tray, as discussed below.

In some embodiments, rather than using the engagement surface, the attachment can have a separate removal surface that can interact with the removal tray. An example of a removal tray is shown in FIG. 10E, the removal tray 1023 is placed over the attachment 1003 and shear force is exerted against the attachment, during the process of removing the removal tray 1023 from the surface of the tooth 1022.

In the example shown in FIG. 10E, the angle 1026 of the upper surface of the attachment 1003 is such that the removal tray 1023 will not slide over the upper surface, but will rather exert a shear force on the upper surface of the attachment. If the tray is made from a material that is not very flexible, pulling, the portion of the tray containing the attachment, downward (toward the end of the tooth) can provide the shear force on the attachment needed to overcome the retention force of the bonding material 1030 to remove the attachment from the tooth.

Provided below are a number of examples regarding the embodiment shown in FIGS. 10A-10E. The examples provide an attachment having degradable or separating characteristics such that, over time, the shape of the attachment can be changed to reveal different active surfaces that can be used over different treatment periods.

In one embodiment, a dental attachment for affixing to a surface of a tooth of a patient and for engagement with a surface of a dental appliance includes a dental attachment body being at least partially constructed from a degradable material and having a first engagement surface thereon, wherein the first engagement surface is shaped to work in combination with an engagement surface on the dental appliance to provide a force vector that is applied to one or more teeth of a patient, and wherein the body includes a second engagement surface hidden beneath an exterior surface of the body that becomes unhidden as the degradable portion of the attachment body degrades over time.

In such an embodiment, the second engagement surface can be made of a different degradable material than the rest of the biodegradable material in the body of the attachment. For example, the second engagement surface can be made from a nondegradable material. This can enable the second engagement surface to be hidden during a first treatment period and then emerge for use in a second treatment period.

As discussed herein, the body can include multiple layers of material with the first layer of material including the first engagement surface and the second layer of material including the second engagement surface that is made of a different material than the first layer. In such an embodiment, the first layer can be biodegradable and it degrades to uncover the second engagement surface or second layer.

In another embodiment, a dental attachment for affixing to a surface of a tooth of a patient and for engagement with a surface of a dental appliance includes a dental attachment body being at least partially constructed from a degradable material and having a first exterior surface with a first engagement surface thereon, wherein the first engagement surface is shaped to work in combination with an engagement surface on the dental appliance to provide a force vector that is applied to one or more teeth of a patient, and wherein the body includes a second engagement surface hidden beneath the first exterior surface of the body that becomes unhidden as the degradable portion of the attachment body degrades over time.

In such an embodiment, the body can include multiple layers of material with a first layer of material including the first engagement surface and a second layer of material including the second engagement surface. The first layer can, for example, be made from a degradable material that degrades to uncover a second exterior surface and the second engagement surface.

The second layer of material including the second engagement surface can be made of a different material than the material of the first layer. In this manner, the first layer can be removed with a catalyst or other element that works on conjunction with the first layer, but may not affect the second engagement surface or, in some implementations, the second layer.

In some embodiments, the attachment can also include a release layer between the first and second layers and wherein the release layer is a degradable material that degrades through interaction with a release agent. The attachment can also include a degradable release layer between the first layer and second layer that can be released to remove the first layer from the attachment body and thereby uncovering the second exterior surface and the second engagement surface.

As stated herein, in some embodiments, the degradable material is a biodegradable material. This can allow for its use in the mouth of patient, in some implementations, among other benefits.

Another embodiment of a dental appliance system having a dental attachment for affixing to a surface of a tooth of a patient and for engagement with a surface of a dental appliance includes a dental appliance body having a first surface shaped to conform to the contours of exterior surfaces of teeth of a patient and including a portion of the first surface that provides an engagement surface on a dental attachment that is to be attached to the exterior surface of one of the teeth. In such an embodiment, the dental attachment can be at least partially constructed from a degradable material and having a body with a first engagement surface thereon, wherein the first engagement surface is shaped to work in combination with the engagement surface on the dental appliance to provide a force vector that is applied to one or more teeth of a patient, and wherein the body includes a second engagement surface hidden beneath an exterior surface of the body that becomes unhidden as the degradable portion of the attachment body degrades over time.

In some such embodiments, the degradable material degrades through interaction with fluid within the mouth of the patient. Degradation can also occur where the degradable material degrades through interaction with light introduced into the mouth of the patient via a light source. In a further example, the degradable material can degrade through interaction with a solvent that dissolves the degradable material. Other elements and/or catalysts can also be utilized in some of these embodiments.

FIG. 11 illustrates a computing system for use in a number of embodiments of the present disclosure. For instance, a computing device 1142 can have a number of components coupled thereto.

The computing device 1142 can include a processor 1144 and a memory 1146. The memory 1146 can have various types of information including data 1148 and executable instructions 1150, as discussed herein.

The processor 1144 can execute instructions 1150 that are stored on an internal or external non-transitory computer device readable medium (CRM). A non-transitory CRM, as used herein, can include volatile and/or non-volatile memory.

Volatile memory can include memory that depends upon power to store information, such as various types of dynamic random access memory (DRAM), among others. Non-volatile memory can include memory that does not depend upon power to store information.

Memory 1146 and/or the processor 1144 may be located on the computing device 1142 or off of the computing device 1142, in some embodiments. As such, as illustrated in the embodiment of FIG. 11, the computing device 1142 can include a network interface 1152. Such an interface 1152 can allow for processing on another networked computing device, can be used to obtain information about the patient (e.g., characteristics of the patient's mouth, treatment planning information or data used for creating a treatment plan information about the materials to be used as an attachment, one or more of the trays described herein, and/or bonding material) and/or can be used to obtain data and/or executable instructions for use with various embodiments provided herein.

As illustrated in the embodiment of FIG. 11, the computing device 1142 can include one or more input and/or output interfaces 1154. Such interfaces 1154 can be used to connect the computing device 1142 with one or more input and/or output devices 1156, 1158, 1140, 1142, 1164.

For example, in the embodiment illustrated in FIG. 11, the input and/or output devices can include a scanning device 1156, a camera dock 1158, an input device 1140 (e.g., a mouse, a keyboard, etc.), a display device 1142 (e.g., a monitor), a printer 1164, and/or one or more other input devices. The input/output interfaces 1154 can receive executable instructions and/or data, storable in the data storage device (e.g., memory), representing a virtual dental model of a patient's dentition.

In some embodiments, the scanning device 1156 can be configured to scan one or more physical dental molds of a patient's dentition. In one or more embodiments, the scanning device 1156 can be configured to scan the patient's dentition, a dental appliance, and/or an attachment directly. The scanning device 1156 can be configured to input data into the computing device 1142 which can then be used for treatment planning and/or generating 3D models of the patient's dentition. This information can also be used to estimate the forces discussed herein

In some embodiments, the camera dock 1158 can receive an input from an imaging device (e.g., a 2D or 3D imaging device) such as a digital camera, a printed photograph scanner, and/or other suitable imaging device. The input from the imaging device can, for example, be stored in memory 1146.

The processor 1144 can execute instructions to provide a visual indication of a treatment plan, a dental appliance, and/or a one or more attachments on the display 1142. The computing device 1142 can be configured to allow a treatment professional or other user to input treatment goals. Input received can be sent to the processor 1144 as data 1148 and/or can be stored in memory 1146.

Such connectivity can allow for the input and/or output of data and/or instructions among other types of information. Some embodiments may be distributed among various computing devices within one or more networks, and such systems as illustrated in FIG. 11 can be beneficial in allowing for the capture, calculation, and/or analysis of information discussed herein.

The processor 1144, can be in communication with the data storage device (e.g., memory 1146), which has the data 1148 stored therein. The processor 1144, in association with the memory 1146, can store and/or utilize data 1148 and/or execute instructions 1150 for creating and/or modeling interactions between an attachment and a tooth; interactions between an attachment and one or more appliances; and/or combinations of interactions between one or more attachments, one or more teeth, and/or other structure in the mouth of the patient, and/or one or more appliances for moving teeth; and/or degradation of an attachment; and/or separation of a portion of an attachment to reveal a hidden portion.

The processor 1144, in association with the memory 1146 can, in addition to or alternatively, store and/or utilize data 1148 and/or execute instructions 1150 for creating and/or modeling attachment template trays, etch trays, removal trays, attachments, and/or bonding and/or releasable materials, as well as a virtual modeling of such items with or without an appliance for moving teeth, and/or one or more teeth. The virtual model of the trays and/or attachments to attach a dental appliance to the teeth of a patient can be used to create a physical dental appliance, the trays themselves, removal tools, and/or attachments, for instance, as discussed further herein. The processor 1144 coupled to the memory 1146 can, for example, include instructions to cause the computing device 1142 to perform a method including, for example, creating a treatment plan based on a virtual model of a jaw of a patient, wherein the treatment plan includes use of one or more attachments and/or trays or other components on the upper and/or lower jaw of a patient.

In some embodiments, the processor 1144 coupled to the memory 1146 can cause the computing device 1142 to perform the method comprising modeling a virtual dental attachment based on the treatment plan, wherein the virtual dental attachment is constructed to provide one or more forces desired by the treatment plan.

In various embodiments, the processor 1144 coupled to the memory 1146 can cause the computing device 1142 to perform the method comprising creating a virtual dental attachment placement apparatus that includes a body having an attachment mounting structure and including a surface having a contour that is shaped to correspond with a contour of an alignment surface of a tooth such that when the contour of the body and the corresponding contour of the tooth are aligned, the dental attachment is placed in the attachment mounting structure, the dental attachment is located at a particular position with respect to an exterior surface of the tooth and having a light source thereon to cure one or more of the attachment material and the bonding material for bonding the attachment to the surface of a patient's tooth.

Such analysis can be accomplished one or more times for a treatment plan. For example, if a treatment plan has 30 stages, it would be possible to have different attachment configurations for each stage or possibly more, if desired. However, in many instances the attachment type, shape, position, and/or orientation may be changed a few times during the treatment plan.

Through use of virtual modeling, attachments can be virtually tested and the best attachment type, shape, position, and/or orientation can be selected without inconveniencing the patient with trial and error of attachments during treatment. Additionally, use of virtual modeling can also allow for custom design of attachment shapes that will be suitable for a specific patient's needs and/or a specific function within an area of a patient's mouth. From such analysis, different physical dental attachment trays and other apparatuses can be created from the virtual dental attachment placement apparatus data that would be utilized to create the attachments needed for the different stages.

Further, the specialized nature of the design of such attachments can also allow the attachments to be made from different materials. In this manner, attachments during a treatment plan or even during one stage can be of one or more different materials that may provide more specialized force distribution than was possible with standard attachments.

In some embodiments, the printer 1144 can be a three dimensional or direct fabrication device that can create a dental appliance directly from instructions from the computing device 1142. Embodiments of the present disclosure utilizing such technology can be particularly beneficial for a variety of reasons. For example, such direct manufacture allows for less waste of materials due to less processing steps and increased specialization of the attachment placement structure, attachment materials, and/or other components of the appliances described herein.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A dental attachment system comprising:
a template body configured to fit over a patient's dentition, the template body having a dental attachment comprising:
an attachment body comprising:
an affixing surface configured to interface with a light curable adhesive coating for bonding the dental attachment to a tooth of a patient; and
an engagement surface configured to engage with a dental appliance for applying a force on the tooth according to a treatment plan; and
a release layer covering the engagement surface; and
one or more radiation sources configured to emit a first range of wavelengths of radiation for curing the light curable adhesive coating of the dental attachment, wherein the one or more radiation sources is further configured to emit a second range of wavelengths of radiation for degrading the release layer such that the release layer can be removed from the dental attachment to expose the engagement surface.

2. The dental attachment system of claim 1, further comprising electronic circuitry configured to electronically activate one or more of the one or more radiation sources.

3. The dental attachment system of claim 2, wherein the electronic circuitry is configured to independently control activation of the one or more radiation sources.

4. The dental attachment system of claim 1, wherein the one or more radiation sources are on a light source tray configured for placement around the template body in the patient's mouth.

5. The dental attachment system of claim 4, wherein an interior surface of the light source tray has a shape that corresponds to a shape of an exterior surface of the template body and is configured to mate with the exterior surface of the template body.

6. The dental attachment system of claim 1, wherein the one or more radiation sources are on the template body.

7. The dental attachment system of claim 6, wherein the one or more radiation sources are embedded within a material forming the template body.

8. The dental attachment system of claim 1, wherein the one or more radiation sources are on a light source element that is attachable to the template body.

9. The dental attachment system of claim 8, wherein the light source element includes one or more electrical contacts that is configured to electrically connect to one or more corresponding electrical contacts of the template body.

10. The dental attachment system of claim 1, wherein the release layer is made of a different material than the attachment body.

11. The dental attachment system of claim 1, wherein the engagement surface is shaped to work in combination with the dental appliance to apply a force vector to the tooth.

12. The dental attachment system of claim 1, further comprising a series of dental appliances each configured to apply repositioning forces against the dental attachment according to the treatment plan.

13. A method of bonding a dental attachment to a tooth of a patient, the method comprising:
placing a template body on the patient's dentition, the template body having the dental attachment, wherein the dental attachment comprises:
an attachment body comprising:
an affixing surface having a light curable adhesive coating for bonding the dental attachment to the tooth of the patient; and
an engagement surface configured to engage with a dental appliance for applying a force on the tooth according to a treatment plan; and
a release layer covering the engagement surface;
activating one or more radiation sources to emit a first range of wavelengths of radiation to cure the light curable adhesive coating and to bond the dental attachment to the tooth; and
activating the one or more radiation sources to emit a second range of wavelengths of radiation to degrade the release layer such that the release layer can be removed from the dental attachment to expose the engagement surface.

14. The method of claim 13, wherein the one or more radiation sources are on the template body.

15. The method of claim 13, further comprising placing at light source tray around the template body in the patient's mouth, wherein the light source tray includes the one or more radiation sources.

16. The method of claim 13, further comprises attaching a light source element the template body, wherein the one or more radiation sources are on the light source element.

17. The method of claim 16, wherein attaching the light source element includes electrically contacting one or more electrical contacts of the light source element with one or more corresponding electrical contacts of the template body.

18. A dental attachment, comprising:
an attachment body comprising:
an affixing surface having a light curable adhesive coating for bonding the dental attachment to a tooth of a patient, wherein the light curable adhesive is configured to cure upon exposure to a first range of wavelengths of radiation; and
an engagement surface configured to engage with a dental appliance for applying a force on the tooth according to a treatment plan; and
a release layer covering the engagement surface, the release layer configured to degrade upon exposure to a second range of wavelengths of radiation to expose the engagement surface.

19. The dental attachment of claim 18, wherein the release layer is made of a different material than the attachment body.

20. The dental attachment of claim 18, wherein the dental attachment is configured to become smaller over a course of orthodontic treatment.
